(19) United States
(12) Patent Application Publication
(10) Pub. No.: US 2018/0188698 A1
(43) Pub. Date: Jul. 5, 2018

(54) ACCURATE TIME RECOVERY FROM GLOBAL NAVIGATION SATELLITE SYSTEM

(71) Applicant: Smart Energy Instruments Inc., Oakville (CA)

(72) Inventors: Donald Jeffrey DIONNE, Oakville (CA); Jennifer Marie McCANN, Oakville (CA)

(73) Assignee: Smart Energy Instruments Inc., Oakville, ON (CA)

(21) Appl. No.: 15/580,717

(22) PCT Filed: Jun. 10, 2015
(86) PCT No.: PCT/CA2015/050535

§ 371 Date: Dec. 8, 2017

(51) Int. Cl. G04R 20/06; G04R 20/04

(52) U.S. Cl. CPC G04R 20/06; G04R 20/04

(57) ABSTRACT

A system for recovering accurate time data from a received satellite signal, including an antenna connected to a remote digital receiver by synchronous communication channel. The antenna converts the satellite signal to IF and digitizes it. A packetizer packetizes digital samples with a time stamp form a local clock domain, which is continuously corrected to match, but for transmission delay, a remote master clock. The digital receiver includes a master clock driven by an oscillator and corrected to the satellite time. It includes a depacketizer to depacketize the digital samples and obtain the time stamp. A satellite signal process obtains the satellite time data and the master clock is corrected based upon the satellite time data and the time stamp. The corrected master time is transmitted to the antenna for updating of the local clock domain at the antenna.

### FIELD

The present application generally relates to time recovery from global navigation satellite system (GNSS) signals.

### BACKGROUND

Many distributed systems require a highly-accurate time source in a plurality of remote locations. GNSS signals are one source of highly-accurate time, but reliably recovering that time data from satellite signals can be difficult in some implementations. Satellite signals are in the GHz band and require a line-of-sight between the orbiting satellite and the receiving ground-based antenna. Many times, the time signal is required for systems in a location remote from the antenna, which introduces a problem in how to receive signals at one location and use the recovered time data at another location.

One option is to place all of the GNSS circuitry outdoors and, once the time signal is recovered, to transmit recovered time data to the remote location; however, when significant accuracy is required, the GNSS circuitry (for example, crystal oscillators) may not necessarily fare well in an outdoor environment.

Another option is to receive the satellite signal at the external antenna and send the GHz-band satellite signals to the remote location for processing using an expensive and low-loss cable. However, such a cable introduces non-negligible cable delay and signal-strength loss, requiring amplification and manual determination and compensation for the delay. It also requires that the signal chain from IF mixer forward be of known and constant delay since the arrival times of the satellite signals are part of the calculations performed by the receiver.

### BRIEF DESCRIPTION OF THE DRAWINGS

Reference will now be made, by way of example, to the accompanying drawings, which show example embodiments of the present application, and in which:

FIG. 1 shows a simplified block diagram of an example system for recovering accurate satellite time;

FIG. 2 illustrates an example process for recovering accurate satellite time; and

FIG. 3 shows a block diagram of one example of a system for satellite time recovery with an active antenna and remote digital receiver.

### DESCRIPTION OF EXAMPLE EMBODIMENTS

In one aspect, the present application discloses a system for recovering accurate time data from a received satellite signal. The system includes an antenna module and a digital receiver remote from the antenna module and connected to the antenna module via a packet communication link to receive the packetized digital samples. The antenna module includes a down-converter to down-convert the received satellite signal to an intermediate frequency signal, an analog-to-digital converter to convert the intermediate frequency signal to digital samples, a local clock, and a packetizer to packetize the digital samples together with a time stamp from the local clock and to transmit the packetized digital samples. The digital receiver includes a master clock driven by an oscillator, a depacketizer to depacketize the digital samples and obtain the time stamp, a satellite signal processor to process the digital samples to obtain satellite time data, a time correction module to correct the master clock based upon the obtained satellite time data and the time stamp, and a packetizer to transmit an updated master clock time to the antenna module via the packet communication link. The local clock is updated to match the transmitted updated master clock time.

In another aspect, the present application describes a method for recovering accurate time data from a satellite signal using an antenna coupled to a digital receiver by a packet communication link. The method includes down-converting the satellite signal at the antenna to an intermediate frequency signal and digitally sampling the intermediate frequency signal to obtain digital samples; packetizing the digital samples with a time stamp from a local clock at the antenna, and transmitting the packetized digital samples and time stamp to the digital receiver over the packet communication link; de-packetizing the digital samples and time stamp, and processing the digital samples to obtain satellite time data; correcting a master clock in the digital receiver based upon the satellite time data and the time stamp; sending an updated master clock time to the antenna via the packet communication link; and updating the local clock at the antenna based upon the updated master clock time.

Other aspects and features of the present application will be understood by those of ordinary skill in the art from a review of the following description of examples in conjunction with the accompanying figures.

Although the embodiments of the present application described below are directed to recovering accurate time from a satellite signal, it will be appreciated that the described systems and methods are also applicable to determining location based upon received satellite signals.

In one aspect, the present application provides a method and system that recovers accurate time data from a satellite signal using an active antenna module to digitize, packetize and time stamp received satellite signals This allows for use of a simple and inexpensive cable run to a remote digital receiver that performs the signal processing to recover time from the satellite signals and to perform correction on the master clock in the digital receiver, and to send a control signal back to the active antenna module to correct the local clock at the antenna.

In another aspect, the digitizing and packetization of the satellite systems with a time stamp, allows the digital receiver to process the satellite signals without concern for processing delay or even in the order received. This may allow for implementations that achieve significant hardware re-use and, thus, reduced cost and circuit complexity.

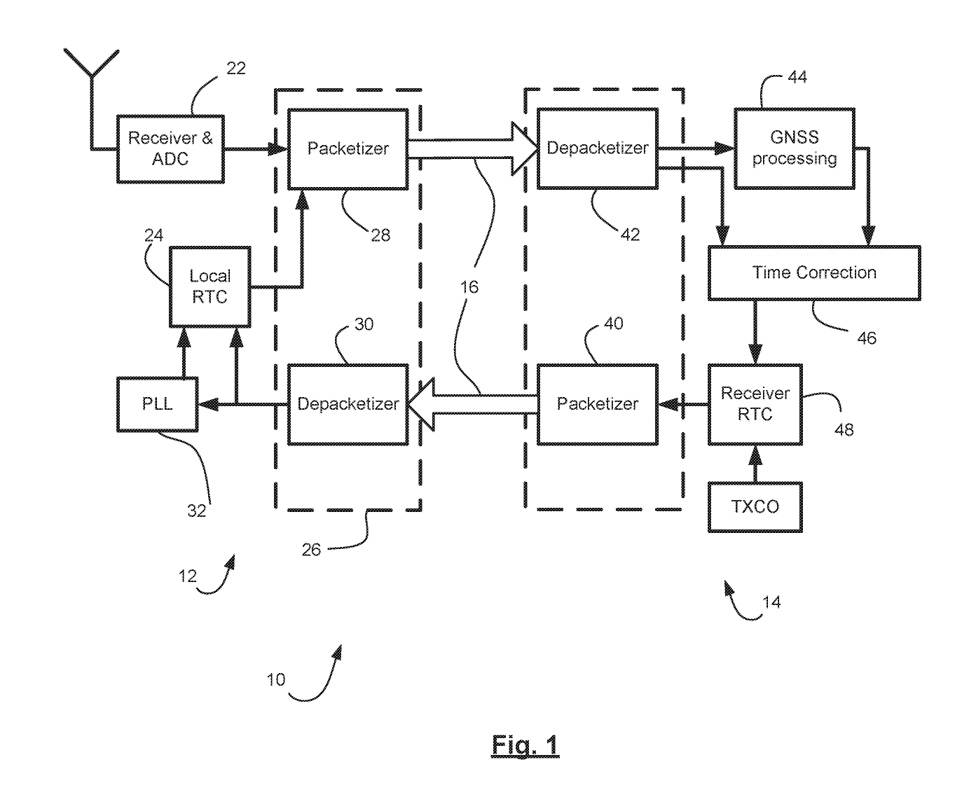

Reference is now made to FIG. 1, which shows, in block diagram form, one example of a satellite time recovery system 10. The example system 10 includes an active antenna module 12 and a digital receiver 14 connected by a communications channel 16. The communication channel 16 may be any suitable cable or conduit for communicating digital signals between the active antenna module 12 and the digital receiver 14.

The active antenna module 12 includes an antenna 20, receiver and analog-to-digital converter 22 and local real-time clock (RTC) 24. The receiver and analog-to-digital converter 22 includes a local oscillator and mixer that converts received satellite signals to intermediate frequency (IF) signals, along with associated filters or other such components, and a digitizer that converts the IF signals to digital signals at a given sample rate.

The digital samples output from the receiver and analog-to-digital converter 22 are input to a communications interface 26. The communications interface 26 includes a packetizer 28 and depacketizer 30. The packetizer 28 may include a first-in-first-out buffer for collecting the digital samples. The buffer may be, for example, 128 or 256 samples, or other sizes depending on the implementation. The packetizer 28 may generate applicable headers, frame sequence numbers, control bits, parity or checksum codes, and other framing data for packaging the digital samples in accordance with the communications protocol being used in a given embodiment.

The packetizer 28 receives a time stamp from the local RTC 24 and inserts the time-stamp in an outgoing packet. In some embodiments, the time stamp is based on the sample time of a first received sample in the packet. In some embodiments, the time stamp is based on the sample time of a last received sample in the packet. In some embodiments, the time stamp is based on the time of the first bit transition on the wire of the packet itself. In other embodiments, the time stamp may be determined at another point in time.

The communication interface 26 may include other components, depending on the details of the communications protocol used over the communication channel 16. In one embodiment, the communication protocol may be carried on a 8b/10b-encoded data link, although many other protocols and data links may be used in other embodiments. It will be understood that the communications interface 26 includes a physical layer for generating and detecting signals in the communication channel 16. In some embodiments, the communication channel 16 is wireless or a combination of wired and wireless.

The depacketizer 30 in the active antenna module 12 receives packetized data from the remote digital receiver 14 over the communications channel 16. The received packetized data includes a master time stamp that the depacketizer extracts and provides to a phase-locked loop (PLL) 32 and to the local RTC 24. The master time stamp is used to correct the local real-time clock 24 to lock it to the master time.

It will be appreciated that the corrected local RTC 24 is actually behind the master time by the non-negligible one-way transmission delay associated with the communication channel 16. Accordingly, the local clock time is locked to master time minus the channel transmission delay. Therefore, all time stamps inserted into outgoing packets by the packetizer 24 will be at master time minus the channel transmission delay. However, the digital receiver 14 will receive the time stamped packet after a further transmission delay. Accordingly, in an embodiment in which the time stamp is fixed based on the first bit transition on the line when transmitting the packetized data, the digital receiver 14 is able to determine the transmission delay based upon the current time on the master clock at the digital receiver 14 at the time of receipt of the start of the packet. The time stamp will be offset from the current master time by two-times (2×) the transmission delay.

In some embodiments, the PLL 32 may receive a clock recovered signal from the depacketizer (e.g. in a 8b/10b implementation). The clock recovered signal may drive the PLL 32 based on the clock rate used on the communications channel 16, and the PLL 32 is then used to drive the local RTC 24. In some other embodiments, the local RTC 24 may be driven by a local crystal oscillator rather than a recovered clock signal from the master, and the received master time may be used to constantly correct for errors in the accuracy of the local crystal oscillator.

The remote digital receiver 14 may supply power to the active antenna module 14 over the communications channel 16, in many embodiments. It may also send configure data or settings for configuring various aspects of the active antenna in some embodiments. For example, it may send gain settings, filter parameters, tuning parameters, etc.

The digital receiver 14 also includes a communications interface 38 containing a packetizer 40 and depacketizer 42. The depacketizer 42 provides the digitally sampled satellite data and antenna local clock time stamp to a GNSS processing block 44 to perform typical processing for recovery of GNSS time data (and location calculations, in some embodiments).

A time correction module 46 receives the recovered GNSS time, and the time stamp data. From the time stamp data and GNSS time, the time correction module 46 corrects for error and drift in the current master time maintained by a master real-time clock (RTC) 48. The master RTC 48 is driven by an accurate local crystal in this example, such as a temperature-controlled crystal oscillator (TCXO) or an oven-controlled crystal oscillator (OCXO). The time correction module 46 is able to compare the recovered GNSS time with the current master time on the basis of knowing the transmission delay, since the local time stamp applied by the antenna module 12 is 1× transmission delay behind the master clock and the time stamp is received by the master module 1× transmission delay after it is applied to the packet. Any expected additional internal processing delay in the digital receiver 14 between receipt of the packet and the recovery of the GNSS time from the GNSS processor 44 may also be taken into account by the time correction module 46.

It will be understood that the time stamp is applied at the antenna module 12 at a predetermined point in the packetizing, for example, at the first bit transition of the packet on the wire of the communications channel 16. Using that point, and knowing the sample rate used in the ADC at the antenna module 12, the time correction module 46 is able to determine the point at which the antenna time was received by the antenna module 12 relative to the local time stamp. In yet another embodiment, two or more timestamps may be inserted in a packet. One time stamp may be determined at a predetermined point in the packetizing and another time stamp may be determined based on data capture time, e.g. upon receipt of a first sample of the detected satellite signal, or the like.

The time correction module 46 thus produces a correction signal for adjusting the time of the master RTC 48.

The master RTC 48 supplies the corrected local time to the packetizer 40, which sends continuous packets to the antenna module 12 containing the master time.

The use of time-stamped digital samples from the active antenna 12 relieves the digital receiver 14 of the burden of processing the GNSS data in strict sequence and in real-time. The digital receiver 14 may resample the data and process the GNSS data at another, much higher, possibly unrelated, data rate. Accordingly, the GNSS baseband processing hardware may be shared for processing multiple receiver channels.

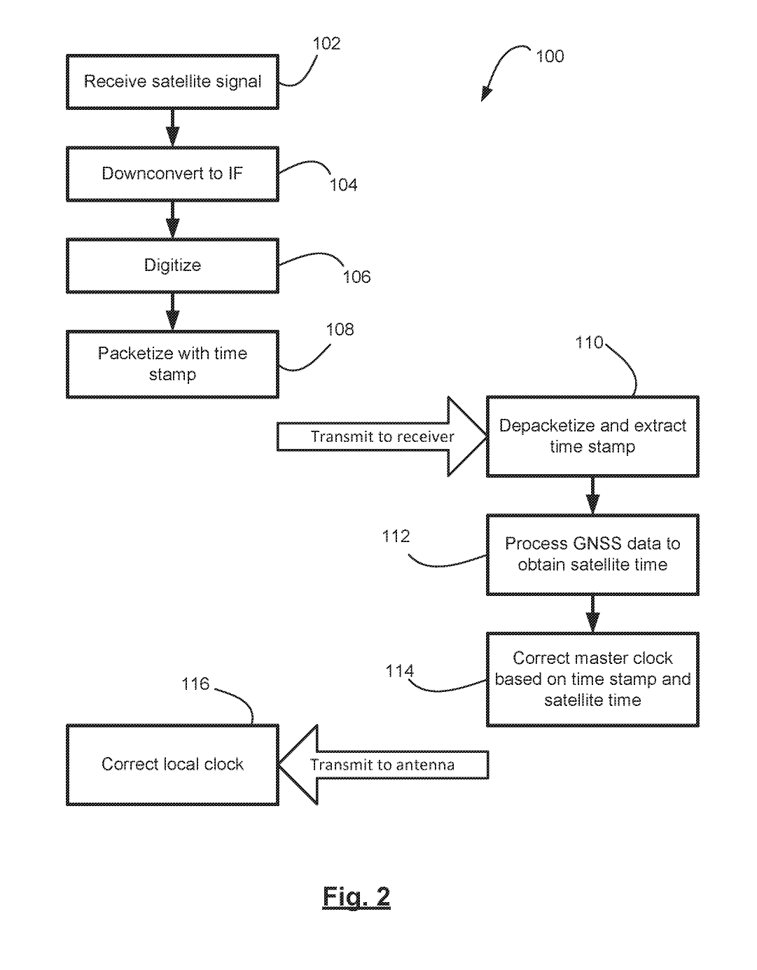

Reference is now made to FIG. 2, which shows one example flow diagram of the process 100 for recovering accurate time from a satellite signal. The process 100 is applied in connection with an antenna system that includes an active antenna module connected to a remote digital receiver by a digital communications channel.

The process 100 includes receiving the satellite signal in operation 102 and down-converting the satellite signal to an intermediate frequency in operation 104. The IF signal is then digitized in operation 106. The digitized samples are accumulated in a buffer until a sufficient number (e.g. 128, 256 or some other number) of samples are ready. The collection of buffered samples are then packetized with a local time stamp, as indicated by operation 108, and transmitted over the digital communication channel to the remote digital receiver. The time stamp, in this example, marks the local time at which the packet transmission is initiated.

At the remote digital receiver, the packet is depacketized in operation 110, and the local time stamp applied to the packet is extracted. The extracted local time stamp can be compared with a master clock time in the digital receiver to determine the transmission delay (the local clock in the antenna is running at 1× the transmission delay behind the master clock). The digital receiver thus knows the time (in the master clock domain) at which the satellite signal was received (accounting for any expected buffer delay at the antenna based on the sampling rate used on the IF signals). It will be understood that in some implementations a correction may be calculated for the TXCO/OCXO local oscillator frequency.

The digital receiver processes the GNSS sample data extracted from the packet to obtain the GNSS time, as indicated by operation 112. The processing of GNSS data may be carried out in a conventional manner, in some embodiments. Once the GNSS time is extracted from the GNSS data, in operation 114 the digital receiver generates a clock correction signal based upon the GNSS time and the master clock. The current master clock time should be related to the GNSS time adjusted to account for the one-way transmission delay and any delay attributable to buffer accumulation (as calculated based on sample rate). The correction signal adjusts the master clock to lock it to the correct satellite time.

The corrected master time is transmitted back to the antenna, whereupon the antenna updates its local RTC in operation 116 to match the received master clock time. It will be appreciated that the local RTC runs at the master clock time offset by the one-way transmission delay.

It will also be understood that in some other embodiments, the active antenna may not maintain a local time clock and insert explicit time stamps in each packet. Instead, all antenna packets may be sent containing an offset value from the last received master time stamp and an identifier (e.g. a packet or sequence no.) of the last received master time stamp. The counter for determining the offset value may be driven by a PLL driven by a clock signal recovered from the incoming packet data from the master. In this manner, the master is able to determine the antenna “local” time based on knowledge of the master time stamp identified in the received packet from the antenna and the offset value. The term “time stamp” and the insertion of an antenna “time stamp” as used in the present application should be understood as broad enough to encompass such embodiments in which an antenna local time is not explicitly inserted in the packets, but is nonetheless derivable from offset/counter data and a master time stamp identifier included in the packets.

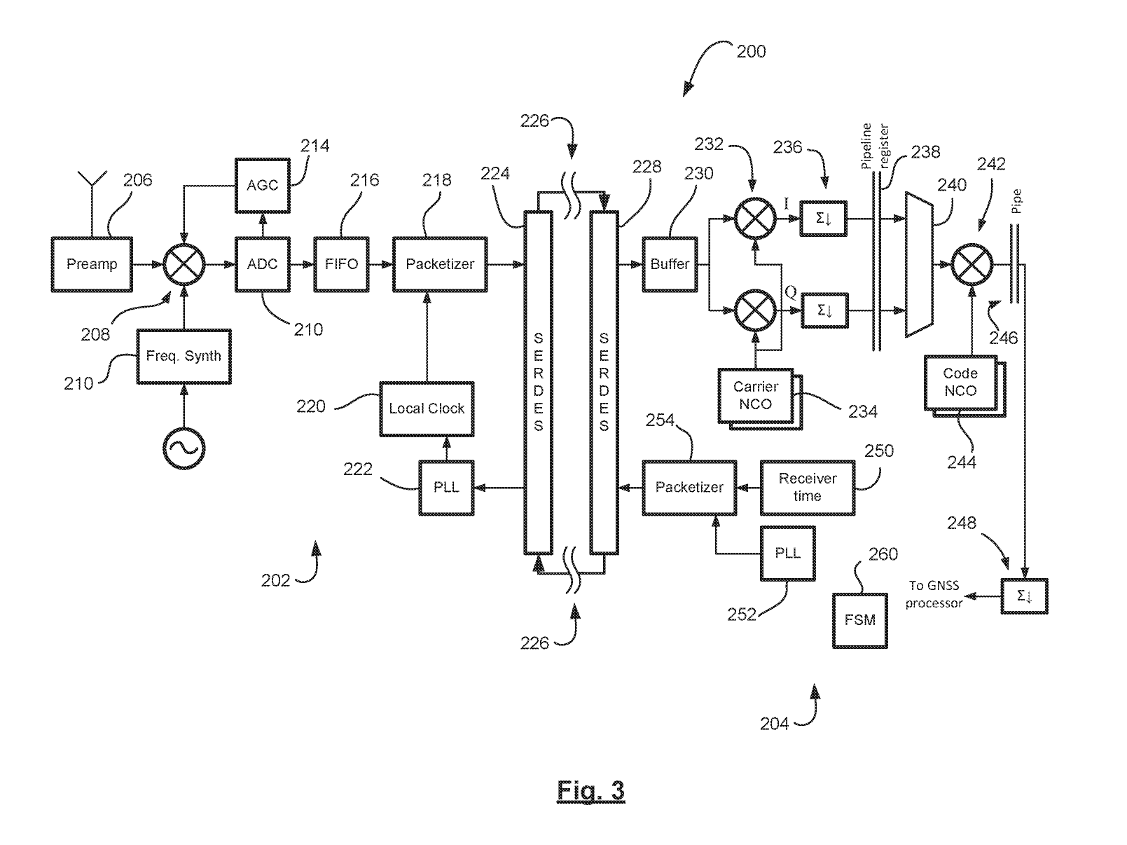

Reference is now made to FIG. 3, which shows a more detailed block diagram of an example system 200 for recovering accurate satellite time. The example system 200 includes an active antenna 202 and a remote digital receiver 204. The active antenna 202 includes an antenna connected to a preamplifier 206 that feeds the amplified satellite signal into a downconverter 208. The downconverter 208 performs downconversion to IF based on an input signal from a frequency synthesizer 210. The IF signal is then digitized by an analog-to-digital converter (ADC) 212. Automatic gain control 214 may be used in the downconversion and digitization process.

The digital samples of the IF signal are input to a FIFO buffer 216 before being packetized by a packetizer 218. The packetizer 218 further inserts a time stamp from the local time register 220. A PLL 222 driven by a recovered clock from the digital receiver 204 may be used to clock the local time 220.

A serializer/deserializer (SERDES) 224 outputs packet data from the packetizer to the synchronous communications channel 226 connecting the active antenna 202 with the remote digital receiver 204. A corresponding SERDES 226 at the digital receiver 204 obtains the transmitted packet data and buffers it in buffer 230. The digital receiver 204 regularly sends a master clock time to the active antenna 202 via the communications channel 226 via packetizer 254, receiver time register 250 and PLL 252.

The digital receiver 204 performs carrier wipe-off using mixers 232 and carrier numerically-controlled oscillators 234, and thereby produces I and Q signals, which are then decimated 236 and pipelined 238. The separate I and Q signals, having been decimated, are multiplexed using multiplexer 240 and code wipe-off is performed as indicated by mixer 242 and code NCOs 244. After further pipeline register 246, the signals may be further decimated 248 and provided to a processor (e.g. a DSP, CPU, ASIC or other digital processing element) for performance of GNSS time extraction and location calculations, in some embodiments.

Notably, the decimation, pipelining and multiplexing allows for significant hardware re-use opportunities. Because the antenna 202 communicates the time of sampling to the digital receiver 204, it is no longer critical that the baseband processing of the GNSS signals occur with known time delay, or even in strict time-of-receipt order. It is thus possible to reorder and/or refactor the calculations and perform them using one block of hardware shared by multiple receiver channels. The digital receiver 204 may process the samples at a higher (and possibly unrelated) sample rate.

It can be seen from the equations which represent carrier and code wipe off, and accumulation, that (provided the arrival time of the packetized IF data is known) it is possible to factor part of the accumulation into a down sampling filter between carrier wipe off and code wipe off, because it is possible to address the samples in the buffer 230 in arbitrary order, and therefore perform carrier mixing on multiple channels in one hardware block time sliced. This reduces the sample rate from that point in the signal chain forward, increasing the number of operations which may be done in the same hardware block on a packet at a given baseband clock frequency. A relatively small and simple finite-state machine (FSM) 260 may be used to control the operation of this single data path, implementing the calculations of the well-known GNSS baseband receiver, but with a minimum of hardware and no duplication of resources, and achieving high utilization of the silicon area in terms of operations at the maximum possible clock speed. The FSM 260 may further generate control signals for other blocks in the digital receiver 204.

In some embodiments, instead of using individual registers to store state in code, carrier and output accumulators, space-efficient register files (small memory blocks) may be used. In many implementations, adders and multipliers may be shared across both receiver channels and early, prompt, late correlations. Depending on the IF sampling rate, packet rate and SERDES data rate used, there may be one or multiple I/Q mixers, whose output is then downsampled and multiplexed into the single code mixer for all receiver channels and Early, Prompt and Late codes (single, separate I and Q are shown for clarity in the illustrated diagram).

In one embodiment, the active antenna 202 effectively resamples the arrival time of the digital samples taken by the ADC 212, bringing them into the receiver local clock domain. This may introduce a periodic time error. This time error is the amplitude of the clock recovery PLL 222 period, but averages to zero. Natural low pass filtering in the digital receiver 204 processing removes this saw-tooth-shaped time jitter.

Various components, for example the frequency synthesizer 210, the AGC 214, the packetizer 218, etc., may receive set signals and provide status signals. The digital receiver 204 is not only able to supply power to the active antenna 202, but is able to exchange command and status signals with components of the antenna 202. Enumeration and identity information, settings and status for gain, AGC, RSSI, and even temperature (relevant to TCXO stability) may be communicated between the antenna 202 and receiver 204. For instance, the receiver 204 may adjust the preamp 206 gain or AGC 214 settings depending on signal strength.

It will be appreciated that the circuits described herein may include other components including hardware and software components (for example, other types of bit shifters, adders, inverters, etc.), one or more microprocessors or microcontrollers (for example, to control the overall operation of the receiver, and to work in conjunction with the bit shifters, adders, inverters, etc. to perform the processes described above).

It will be understood that the above-described devices may be implemented partly in hardware and partly in software. In some embodiments, the implementation may include one or more field programmable gate arrays (FPGA). In some embodiments, the implementation may include one or more application-specific integrated circuits (ASIC). The selection of particular hardware components may be based upon cost, speed, operating environment, etc. The selection and programming of such components will be within the understanding of a person of ordinary skill in the art having regard to the detailed description provided herein.

In yet a further aspect, the present application discloses a non-transitory computer-readable medium having stored thereon computer-executable instructions which, when executed by a processor, configure the processor to execute any one or more of the processes described above.

Certain adaptations and modifications of the described embodiments can be made. Therefore, the above-discussed embodiments are considered to be illustrative and not restrictive.

What is claimed is:

1. A system for recovering accurate time data from a received satellite signal, the system comprising:
an antenna module including
a down-converter to down-convert the received satellite signal to an intermediate frequency signal,
an analog-to-digital converter to convert the intermediate frequency signal to digital samples,
a local clock, and
a packetizer to packetize the digital samples together with a time stamp from the local clock and to transmit the packetized digital samples; and
a digital receiver remote from the antenna module and connected to the antenna module via a packet communication link to receive the packetized digital samples, the digital receiver including
a master clock driven by an oscillator,
a depacketizer to depacketize the digital samples and obtain the time stamp,
a satellite signal processor to process the digital samples to obtain satellite time data,
a time correction module to correct the master clock based upon the obtained satellite time data and the time stamp, and
a packetizer to transmit an updated master clock time to the antenna module via the packet communication link,
and wherein the local clock is updated to match the transmitted updated master clock time.

2. The system claimed in claim 1, wherein the time correction module is to determine a transmission delay from the antenna to the digital receiver and a time of receipt of the satellite signal based upon the time stamp and the transmission delay, and to lock the master clock to the satellite time adjusted based upon the time of receipt.

3. The system claimed in claim 1, wherein the packet communication link comprises a synchronous digital channel.

4. The system claimed in claim 3, wherein the synchronous digital channel employs a DC-free line code for signaling.

5. The system claimed in claim 1, wherein the DC-free line code comprises 8b/10b encoding.

6. The system claimed in claim 1, wherein the antenna module includes a buffer to store the digital samples until a predetermined number of digital samples are in the buffer, and wherein the packetizer packetizing the predetermined number of digital samples together with the time stamp in a prescribed frame format for transmission over the packet communication link.

7. The system claimed in claim 6, wherein the packetizer obtains the time stamp from the local clock at the first bit transition of the packet when transmitting.

8. The system claimed in claim 1, wherein the antenna module further comprises a phase-locked loop to recover a clock signal from the packet communication link and driving the local clock using the clock signal.

9. The system claimed in claim 1, wherein satellite signal processor includes a down-converter to convert the digital samples to baseband and a processor to perform global navigation satellite system processing on the converted digital samples.

10. The system claimed in claim 9, wherein the digital samples include two or more satellite channels and wherein the processor includes a decimator and multiplexor and wherein the processing includes processing in parallel with hardware re-use.

11. A method for recovering accurate time data from a satellite signal using an antenna coupled to a digital receiver by a packet communication link, the method comprising:
down-converting the satellite signal at the antenna to an intermediate frequency signal and digitally sampling the intermediate frequency signal to obtain digital samples;
packetizing the digital samples with a time stamp from a local clock at the antenna, and transmitting the packetized digital samples and time stamp to the digital receiver over the packet communication link;
de-packetizing the digital samples and time stamp, and processing the digital samples to obtain satellite time data;
correcting a master clock in the digital receiver based upon the satellite time data and the time stamp;
sending an updated master clock time to the antenna via the packet communication link; and
updating the local clock at the antenna based upon the updated master clock time.

12. The method claimed in claim 1, wherein correcting the master clock includes determining a transmission delay from the antenna to the digital receiver and a time of receipt of the satellite signal based upon the time stamp and the transmission delay, and locking the master clock time to the satellite time adjusted based on the time of receipt.

13. The method claimed in claim 1, wherein the packet communication link comprises a synchronous digital channel.

14. The method claimed in claim 3, wherein the synchronous digital channel employs a DC-free line code for signaling.

15. The method claimed in claim 1, wherein the DC-free line code comprises 8b/10b encoding.

16. The method claimed in claim 1, wherein packetizing the digital samples comprises buffering the digital samples until a predetermined number of digital samples are in a buffer and then transmitting the packetized digital samples.

17. The method claimed in claim 6, wherein the time stamp is fixed at the first bit transition of the packet when transmitting.

18. The method claimed in claim 1, further comprising, at the antenna, recovering a clock signal from the packet communication link and driving the local clock using the clock signal.

19. The method claimed in claim 1, wherein processing the digital samples comprises converting the digital samples to baseband and performing global navigation satellite system processing on the converted digital samples.

20. The method claimed in claim 9, wherein the digital samples include two or more satellite channels and wherein processing the digital samples includes decimating and multiplexing the digital samples for the two or more satellite channels, and wherein the processing include processing in parallel.
